(19) United States
(12) Patent Application Publication
(10) Pub. No.: US 2005/0232598 A1
(43) Pub. Date: Oct. 20, 2005

(54) Method, apparatus, and program for extracting thumbnail picture

(75) Inventor: Hiroto Kawauchi, Tokyo (JP)

Correspondence Address: ARENT FOX PLLC, 1050 CONNECTICUT AVENUE, N.W., SUITE 400, WASHINGTON, DC, 20036, US

(73) Assignee: Pioneer Corporation

(21) Appl. No.: 11/094,764

(22) Filed: Mar. 31, 2005

(30) Foreign Application Priority Data
Mar. 31, 2004 (JP) JP2004-102589

(51) Int. Cl. H04N 5/781

(52) U.S. Cl. 386/95; 386/125

(57) ABSTRACT

It is an object of the invention to extract thumbnail picture having a higher index function, to arrange thumbnail pictures of the respective titles recorded in recording medium onto an easily understandable picture such as title picture of entertainment program. When one of a plurality of titles is selected and a criteria thumbnail picture Si is set by a user, a selected thumbnail picture Si is extracted as criteria fragment information (criteria frame), and its frame number is stored in memory S [i] (i=0). Then, the correlation of the criteria thumbnail picture Si in each frame of each title is found with respect to titles T[1]-T[Tn], thereby automatically detecting the frame number of a frame having the highest correlation and storing the same in memory S[i].

### BACKGROUND OF THE INVENTION

The present invention relates to a method, an apparatus, and a program for extracting thumbnail picture.

The present application claims priority from Japanese Application No. 2004-102589, the disclosure of which is incorporated herein by reference.

In recent years, there have been in broad use some types of apparatuses for reproducibly recording digital information of picture and sound in a large capacity recording medium. Generally, such an apparatus is equipped with recording and reproducing functions for recording information on and reproducing the same from a fixed type recording medium (such as a hard disk or the like) or a movable recording medium (an optical disk such as DVD), capable of selectively recording information on various types of recording mediums, as well as copying and transmitting information between different information recording mediums. Such apparatuses include those which are commercially available as special-purpose machines (such as DVD recorder containing a hard disk), and those capable of using the recording medium of a general-purpose computer (PC or the like) as well as related recording/reproducing apparatus which has installed therein a program for recording and reproducing video and audio information.

The aforementioned apparatus records video and audio information on recording medium in an information unit called “title” and is capable of reproducing these information in each information unit. In fact, such “title” forms a unit for each content of one entertainment program when TV broadcast is received and recorded, but also forms a unit for information of each photograph cut or for information formed by dividing or combining these photograph cuts when recording information photographed by video camera.

Moreover, the aforementioned apparatus is provided with an index function using OSD (On Screen Display) for managing the information of each title recorded on a recording medium. Actually, such index function is formed by tabling character information such as date and time of information recording for each title and titles inputted by users, which information can be displayed so as to be selectively operated for each title. Alternatively, in order to increase AV (AudioNideo) effect, a generally adopted method is to reproduce compressed audio and video information called “thumbnail” for each title and to impose the information as index information on OSD.

Although the index function using such thumbnail pictures makes it possible for thumbnail pictures to be arranged and displayed on the screen of the apparatus for each title, such thumbnail pictures are in fact information fragments acquired by cutting video and audio information from the information of each title and compressing the same. As a result, a user is allowed to grasp the contents of each title simply by looking at a thumbnail picture. In this way, it is possible for a user to selectively operate a thumbnail picture of a title desired by him or her simply by looking at a plurality of thumbnail pictures.

Conventionally, a thumbnail picture can be extracted in accordance with certain rules determined by individual apparatus. In detail, an extracted thumbnail picture is usually produced based on the front portion of an extracted title or based on the information separated from the front portion by a predetermined picture recording time or a predetermined reproducing time. Further, Japanese Unexamined Patent Application Publication No. 2003-32581 teaches that a user is allowed to designate a specific time for extracting a thumbnail from the information of each title and to designate an information position.

However, when extracting a thumbnail picture as described above, if TV broadcast is received and recorded, commercial advertisements can make it impossible to effectively extract a thumbnail picture. Namely, the start of an entertainment program to be recorded usually fails to be coincident with the start of its feature portion. In other words, at the start of a TV program, several commercial advertisements are usually broadcasted before its feature portion. As a result, if a program is designed such that a thumbnail picture may be extracted from the head portion of a title or from certain information separated by a predetermined picture recording or reproducing time from the head portion, almost all the thumbnail pictures will become commercial advertisement pictures, hence rendering it impossible to grasp the contents of a program of a title from a thumbnail picture.

For this reason, if it is desired to grasp the contents of an entertainment program from a thumbnail picture, a user has to perform a series of troublesome operations including at first playing back the recorded contents, designating any desired picture during the playback, so as to change the information which produces thumbnail and to remake thumbnail.

On the other hand, according to the above-described prior art, it is possible for a user to designate a timing for extracting a thumbnail picture in advance of program recording, so that it is possible to obtain a thumbnail picture free from any commercial advertisement. Further, even when several titles stored in a hard disk are collected and authoring is performed, if a timing is set for extracting a thumbnail picture with respect to a title, it is possible to perform a package change so as to extract thumbnail pictures at the same timing with respect to other titles.

However, in order to further improve an index function of each thumbnail picture, and for example, in order to set on a thumbnail picture a title picture of recorded contents, if there is a delay in the start of picture recording or a delay in the start of an entertainment program due to a specific circumstance on the program distribution side, or if title pictures of programs of different titles appear at different times, an extraction of thumbnail picture only based on an extraction timing or an extracting position like the aforementioned prior art will be difficult to have all the thumbnail pictures of a plurality of titles to be coincident with title pictures. Accordingly, if it is desired to make the thumbnail pictures of all titles coincident with title pictures at the time of authoring a plurality of recorded titles, it is still necessary for a user to perform his or her manual operation to set a timing for thumbnail extraction for each title, hence making it impossible to avoid a troublesome operation.

### SUMMARY OF THE INVENTION

The present invention is to solve the above-discussed problem and it is an object of the invention to extract thumbnail pictures each having a high index function, to enable the thumbnail picture of each title recorded on recording medium to be arranged on an easily understandable picture such as a title picture of an entertainment program, and to effectively and easily extract a thumbnail picture at the time of authoring or the like.

In order to achieve the above object, the present invention is characterized by at least the following aspects.

According to one aspect of the present invention, there is provided a method of extracting thumbnail picture for each information unit from video and audio information recorded in a plurality of information units in recording medium, comprising the steps of: extracting criteria fragment information in accordance with a thumbnail picture set in one information unit; finding a correlation between fragment information in other information unit and the criteria fragment information; and extracting thumbnail picture of the information unit in accordance with the fragment information having the highest correlation with respect to aforementioned other information unit.

According to another aspect of the present invention, there is provided an apparatus for extracting thumbnail picture for each information unit from video and audio information recorded in a plurality of information units in recording medium, comprising: a section for extracting criteria fragment information in accordance with a thumbnail picture set in one information unit; a section for finding a correlation between fragment information in other information unit and the criteria fragment information; and a section for extracting thumbnail picture of the information unit in accordance with the fragment information having the highest correlation with respect to the aforementioned other information unit.

According to a further aspect of the present invention, there is provided a program for a computer to function as an apparatus for extracting thumbnail picture for each information unit from video and audio information recorded in a plurality of information units in recording medium. Specifically, the computer operates by virtue of the program to function as: a section for extracting criteria fragment information in accordance with a thumbnail picture set in one information unit; a section for finding a correlation between fragment information in other information unit and the criteria fragment information; and a section for extracting thumbnail picture of the information unit in accordance with the fragment information having the highest correlation with respect to the aforementioned other information unit.

### BRIEF DESCRIPTION OF THE DRAWINGS

These and other objects and advantages of the present invention will become clear from the following description with reference to the accompanying drawings, wherein:

FIG. 1 is an explanatory flow chart showing a basic flow of a method for extracting thumbnail picture, according to one embodiment of the present invention;

FIG. 2 is an explanatory flow chart showing a basic flow of another method for extracting thumbnail picture, according to another embodiment of the present invention;

FIG. 3 is an explanatory view showing a picture recording and reproducing apparatus having an authoring function capable of realizing the method for extracting thumbnail picture, according to an embodiment of the present invention;

FIG. 4 is a list showing video and audio information recorded on the hard disk of a hard disk unit; and

FIG. 5 shows an example of thumbnail pictures according to an embodiment of the present invention.

### DETAILED DESCRIPTION OF THE PREFERRED EMBODIMENTS

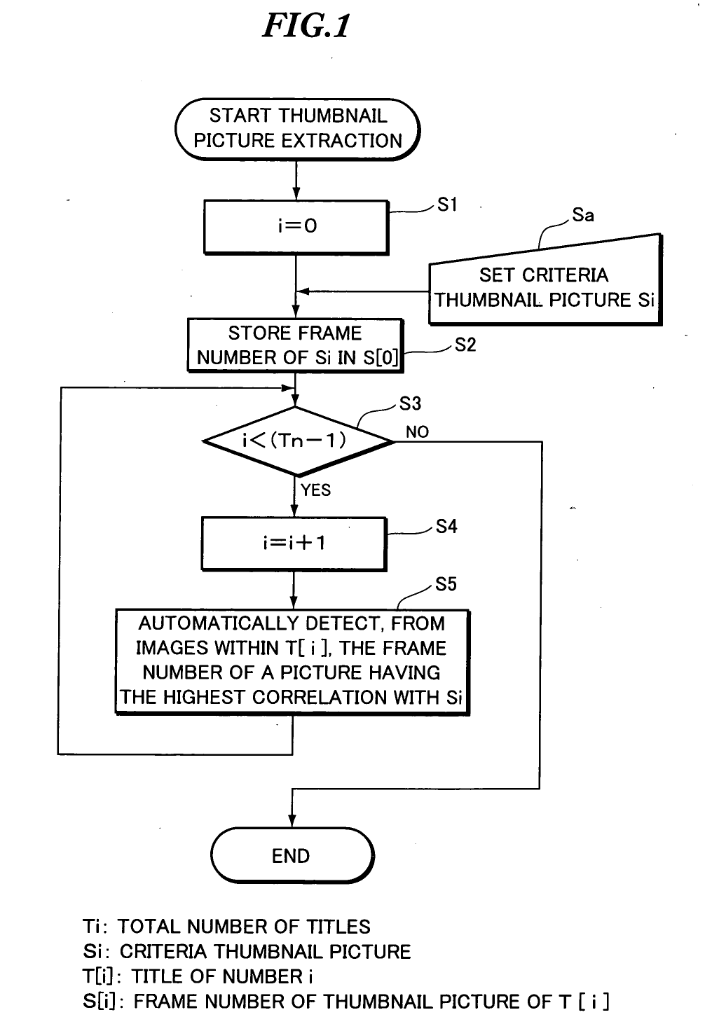

Hereafter, an embodiment of the present invention will be described with reference to the accompanying drawings. FIG. 1 is a flow chart showing a basic flow of a method for extracting thumbnail picture, based on one embodiment of the present invention. As shown, the method of the invention is provided for extracting thumbnail picture of each information unit from video and audio information recorded on recording medium in accordance with a plurality of information units. In detail, the method comprises: extracting criteria fragment information in accordance with thumbnail picture set in one information unit; finding a correlation between the fragment information in other information unit and the above-mentioned criteria fragment information; and extracting the thumbnail picture of the above information unit in accordance with the fragment information having the highest correlation with respect to the aforementioned other information unit.

Here, so-called information units are units for indicating a series of reducible information among digital video and audio information recorded in recording medium, while units having recorded therein video information are units corresponding to the aforementioned titles. In this way, video information of each title is recorded in recording medium, with an example being video information continuously reducible within one title.

On the other hand, so-called thumbnail picture consists of fragment information acquired by taking video and audio information from the title and compressing the same. However, since dynamic video information is usually a collection of unit static pictures (frames), it is possible to extract as thumbnail picture fragment information consisting of one or more static units.

Next, a process for extracting thumbnail picture will be described with reference to FIG. 1. As shown, when one of a plurality of titles is selected and a criteria thumbnail picture Si is set by a user (Sa), the selected thumbnail picture Si is extracted as criteria fragment information (criteria frame), with frame number stored in a memory S [i] (i=0) (S1-S2).

Next, with respect to target titles T[1]-T[Tn], the correlations between picture frames and the criteria thumbnail picture Si in each frame of each title are found so as to automatically detect the number of a frame having the highest correlation and to store the same in the memory S [i]. Namely, the numbers of frames extracted as thumbnail pictures of the respective titles T[1]-T[Tn] are stored in memories S[1]-S[Tn] (S3-S5).

In this way, the thumbnail pictures extracted from the respective titles T[1]-T[Tn] will all become frames having the highest correlation within titles with respect to the criteria thumbnail picture Si. Accordingly, if, with respect to one of a plurality of target titles, a title picture or the like is extracted and criteria thumbnail picture Si is set up, it is possible to automatically extract the same title picture as a thumbnail picture with respect to other titles.

Here, the criteria frame (criteria fragment information) serving as the criteria thumbnail picture Si is video information and/or audio information corresponding to the thumbnail picture in one title (information unit) selected by a user, while frames (fragment information) in other titles (information units) are frames (fragment information) of video information and/or frames (fragment information) of audio information in these titles (information unit). The aforementioned correlation is a video correlation among video information and/or an audio correlation among audio information.

Namely, an object requiring a correlation may be either a video information or an audio information or both. Generally, in an entertainment program such as a drama, since a common sound (a theme song or the like) is played along with a title picture, if video information is combined with audio information, it is possible to extract a thumbnail picture consisting of information having a high correlation. Further, when extracting a title picture, it is possible that video information has a low correlation while audio information can have a high correlation. In this way, it is possible to extract a desired title picture as a thumbnail picture by obtaining a correlation of only video information.

Moreover, criteria thumbnail pictures (criteria fragment information) are extracted from two titles (information units) respectively, thereby extracting thumbnail pictures of other titles (information units), based on the frames (fragment information) having a high correlation with both of the extracted criteria thumbnail pictures (criteria fragment information).

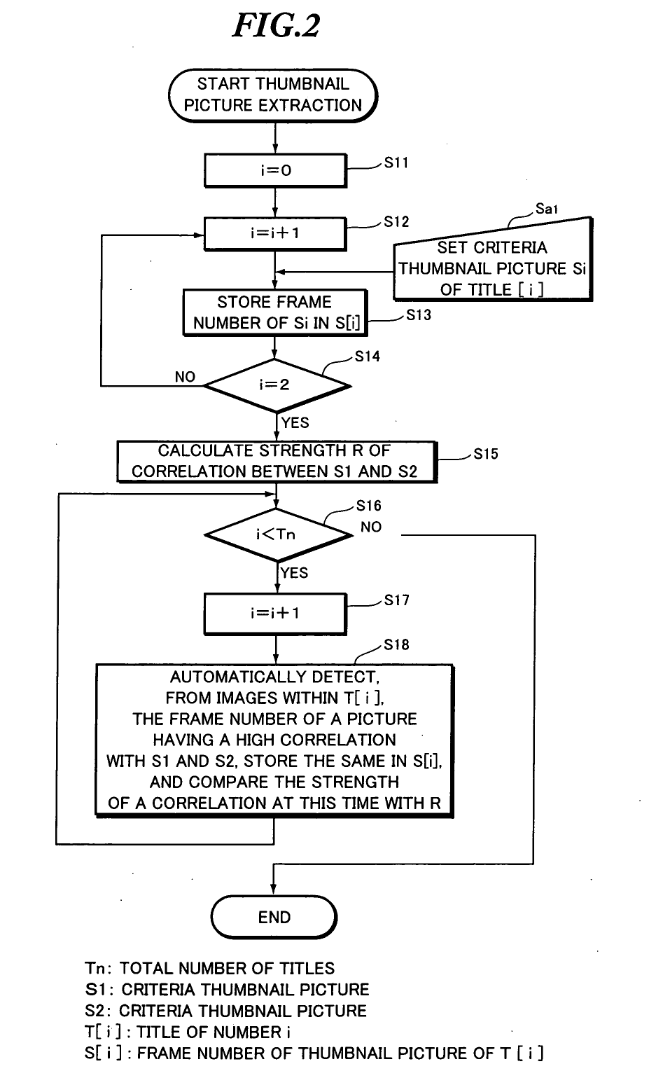

The above-mentioned process can be described with reference to FIG. 2. At first, a user selects two titles T [1] and T [2], and then sets from the two titles the criteria thumbnail pictures S1 and S2 (S11-S14). Subsequently, the strength R of a correlation between the criteria thumbnail pictures S1 and S2 (S15) are calculated.

Next, frame numbers of pictures having a high correlation with the criteria thumbnail pictures S1 and S2 are detected automatically with respect to other titles T[3]-T[Tn], and then stored in S[3]-S[Tn]. At this time, if each correlation is compared with the strength R of the correlation between the criteria thumbnail pictures S1 and S2, it is possible to extract a thumbnail picture from which a desired correlation can be obtained. In this way, by further increasing the criteria thumbnail pictures set by user, it is possible to increase the precision of extracting thumbnail picture having a high correlation.

Moreover, in addition to the above-described automatic extraction, it is also possible to extract thumbnail pictures of other titles (information units) with reference to text information corresponding to the thumbnail picture of one title (information unit) set by a user. That is, in addition to the automatic extraction based on the correlation between video information and audio information, it is possible to increase an extraction rate of extracting thumbnail picture having a high correlation by referring to a similarity of text information. Here, as the text information, it is allowed to adopt an occurrence frame number of the criteria thumbnail picture Si in the thumbnail picture setup by a user, and a static frame number surrounding the criteria thumbnail picture Si, and it is also allowed to adopt an area having a particularly high correlation (such an area is a range extending from one frame number to another frame number) when using two criteria thumbnail pictures. In this way, it becomes possible to increase the precision of extracting thumbnail picture having a high correlation.

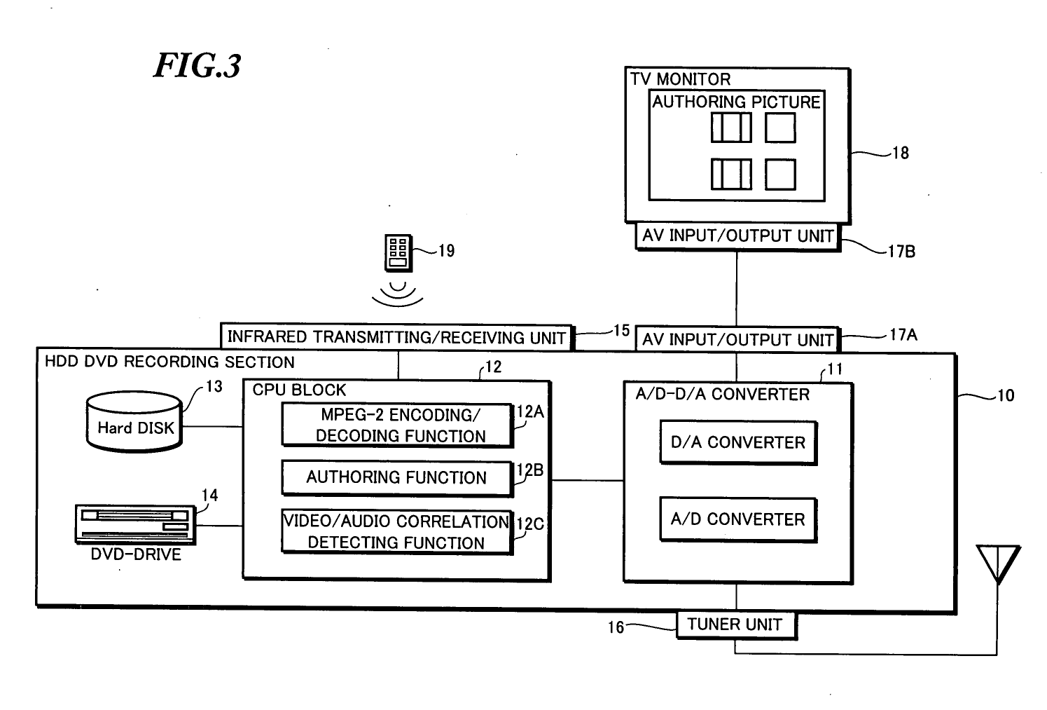

FIG. 3 is an explanatory view showing a video recording and reproducing apparatus having an authoring function capable of realizing a thumbnail picture extraction method according an embodiment of the present invention. As shown, the video recording and reproducing apparatus comprises a main body 10, an A/D-D/A conversion section 11, a CPU block 12, a hard disk unit 13, and a DVD drive unit 14.

The A/D-D/A conversion section 11 converts into digital signals the broadcasted video and audio signals inputted from a tuner section 16 and the analog video and audio signals inputted from an AV input/output unit 17A, and also converts the digital signals fed from the main body 10 into analogue signals and outputs the same through the AV input/output unit 17A.

The CPU block 12 is a control block having at least an MPEG-2 encoding/decoding function 12A, and authoring function 12B, and an video/audio correlation detecting function 12C. In detail, the CPU block 12 has such a fundamental function that the video and audio signals inputted through the A/D-D/A conversion section 11 are outputted to the hard disk unit 13 or the DVD drive unit 14, while the video and audio signals from the hard disk unit 13 or the DVD drive unit 14 are outputted through the A/D-D/A conversion section 11. Besides, the video and audio signals recorded in the hard disk unit 13 are processed by an authorizing function or the like recorded in DVD by the DVD drive unit. Further, by providing the video/audio correlation detecting function 12C, it is possible to realize the thumbnail picture extraction method according to the above embodiment of the present invention.

Moreover, the CPU block 12 receives through an infrared transmitter/receiver 15 an input signal fed from an input device (remote control) 19 and process the same. A monitor 18 is connected through an AV input/output unit 17B to the AV input/output unit 17A, thereby allowing the displaying of the video and audio signals outputted from the main body 10.

Such video recording and reproducing apparatus, which is provided with the video/audio correlation detecting function 12C, can extract the thumbnail picture of each information unit from the video and audio information recorded in a plurality of information units in recording medium. Specifically, the apparatus can serve as a thumbnail picture extraction apparatus containing means for extracting criteria fragment information in accordance with thumbnail picture set in one information unit, and means for finding a correlation between fragment information and criteria fragment information in other information unit, as well as means for extracting the thumbnail picture of the aforementioned information unit in accordance with fragment information having a high correlation with respect to the aforementioned other information unit.

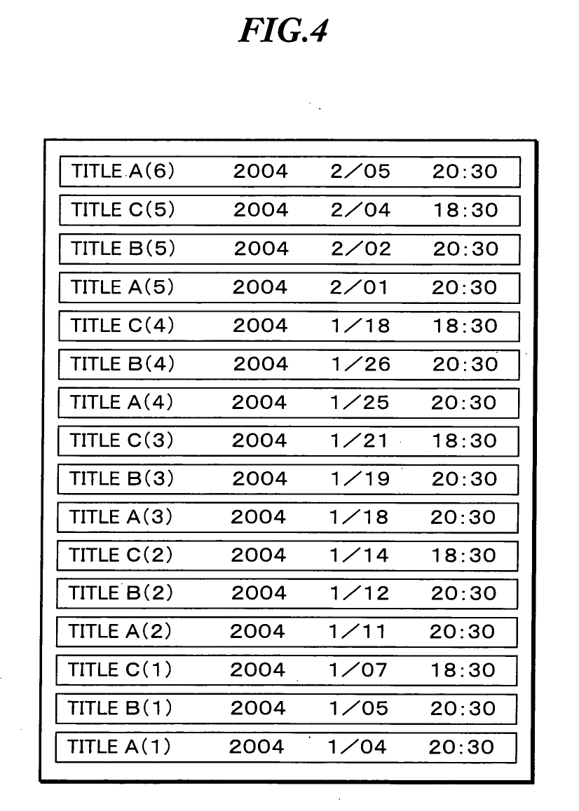

Next, description will be given to explain an example in which thumbnail picture is extracted at the time of authoring the above function. FIG. 4 is a list indicating video and audio information recorded in the hard disk of the hard disk unit 13. Here, the example shows that with respect to the titles recorded in an order of recording operation starting times on the hard disk, only an information relating to title A (i) (i=1-6) is retreated from the hard disk and recorded in DVD, thereby extracting a thumbnail picture coincident with the title picture at this time.

At this time, although titles A(1)-A(6) are retreated successively by the authoring function and recorded on DVD, the criteria thumbnail picture Si will be set by a user at the time of recording title A (1). In this way, the frame number of the criteria thumbnail picture Si in title A(1) is stored at S[0], and the data of S[0] is then written in an information management area of the DVD. Then, when a next title A(2) is recorded, a correlation between all the frames of title A(2) and the criteria thumbnail picture Si is found, the frame number of a frame having the highest correlation is stored in S[2], while the data of S[2] will be written in the information management area of DVD. Subsequently, when the same operation is repeated and all the titles A(1)-A(6) are recorded in DVD, the frame numbers of the thumbnail pictures of each respective titles A(1)-A(6) will be automatically written in the information management area of the DVD.

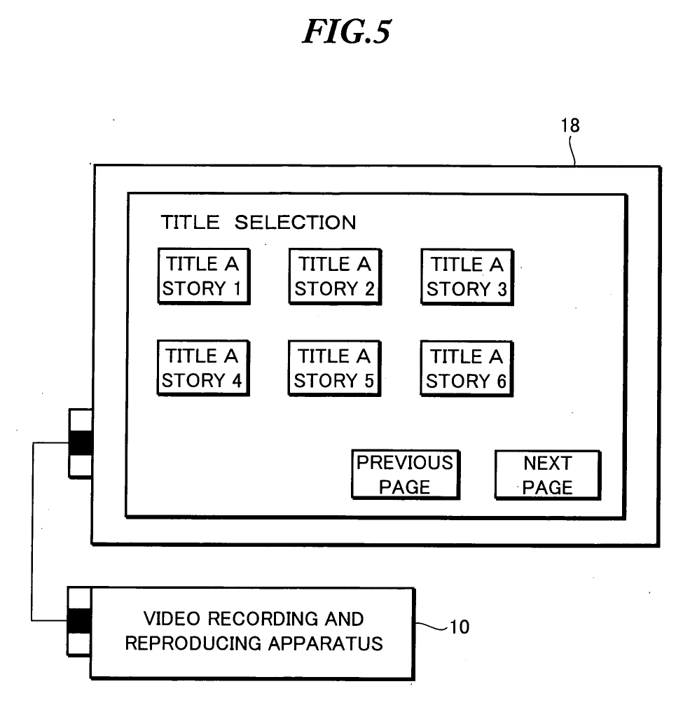

When the DVD is played back, it is possible to obtain thumbnail pictures as shown in FIG. 5. That is, the thumbnail pictures displayed on the monitor 18 by the playback signals from the video recording and reproducing apparatus (apparatus main body 10) will all become related title pictures. In this way, it is possible to easily recognize the contents consisting of a plurality of titles recorded in DVD, thus making it possible to easily select and play back a user's desired title.

The above description has explained an example in which a special video recording and reproducing apparatus is used to extract thumbnail picture. However, in case where a computer such as PC is used to provide a video recording and reproducing function, it is possible to obtain the above-described thumbnail picture extracting function by virtue of a program which can be executed by computer.

As described above, using the method, apparatus and program for extracting thumbnail picture according to the above-discussed embodiment of the present invention makes it possible to extract thumbnail pictures having a higher index function, to arrange thumbnail pictures of the respective titles recorded in recording medium on easily understandable pictures such as title pictures of entertainment program. Further, it is also possible to effectively and easily extract thumbnail pictures at the time of authoring or the like.

While there has been described what are at present considered to be preferred embodiments of the present invention, it will be understood that various modifications may be made thereto, and it is intended that the appended claims cover all such modifications as fall within the true spirit and scope of the invention.

1. A method of extracting thumbnail picture for each information unit from video and audio information recorded in a plurality of information units in recording medium, comprising the steps of:
extracting criteria fragment information in accordance with a thumbnail picture set in one information unit;
finding a correlation between fragment information in other information unit and said criteria fragment information; and
extracting thumbnail picture of said information unit in accordance with the fragment information having the highest correlation with respect to said other information unit.

2. The method according to claim 1, wherein
said criteria fragment information is video information and/or audio information corresponding to the thumbnail picture in said one information unit;
said fragment information in said other information unit is fragment information of video information and/or fragment information of audio information in said information unit;
said correlation is a video correlation among video information and/or an audio correlation among audio information.

3. The method according to claim 1, wherein said criteria fragment information is extracted from two information units respectively, while the thumbnail picture of said other information unit is extracted in accordance with said fragment information having a high correlation with both of the two extracted criteria fragment information.

4. The method according to claim 1, wherein the thumbnail picture of said other information unit is extracted with reference to text information corresponding to the thumbnail picture set in said one information unit.

5. An apparatus for extracting thumbnail picture for each information unit from video and audio information recorded in a plurality of information units in recording medium, comprising:
a section for extracting criteria fragment information in accordance with a thumbnail picture set in one information unit;
a section for finding a correlation between fragment information in other information unit and said criteria fragment information; and
a section for extracting thumbnail picture of said information unit in accordance with the fragment information having the highest correlation with respect to said other information unit.

6. A program for a computer to function as an apparatus for extracting thumbnail picture for each information unit from video and audio information recorded in a plurality of information units in recording medium, wherein
said computer operates by virtue of said program to function as:
a section for extracting criteria fragment information in accordance with a thumbnail picture set in one information unit;
a section for finding a correlation between fragment information in other information unit and said criteria fragment information; and
a section for extracting thumbnail picture of said information unit in accordance with the fragment information having the highest correlation with respect to said other information unit.

7. The method according to claim 2, wherein said criteria fragment information is extracted from two information units respectively, while the thumbnail picture of said other information unit is extracted in accordance with said fragment information having a high correlation with both of the two extracted criteria fragment information.

8. The method according to claim 2, wherein the thumbnail picture of said other information unit is extracted with reference to text information corresponding to the thumbnail picture set in said one information unit.

9. The method according to claim 3, wherein the thumbnail picture of said other information unit is extracted with reference to text information corresponding to the thumbnail picture set in said one information unit.

10. The method according to claim 7, wherein the thumbnail picture of said other information unit is extracted with reference to text information corresponding to the thumbnail picture set in said one information unit.
